(19) United States
(12) Patent Application Publication
(10) Pub. No.: US 2007/0076531 A1
(43) Pub. Date: Apr. 5, 2007

(54) Horology crystal with three-dimensional decoration

(76) Inventor: Cosetta Schiavolini, Ventimiglia (IT)

Correspondence Address: BROOKS KUSHMAN P.C., 1000 TOWN CENTER, TWENTY-SECOND FLOOR, SOUTHFIELD, MI, 48075, US

(21) Appl. No.: 10/595,779

(22) PCT Filed: Nov. 10, 2004
(86) PCT No.: PCT/IT04/00618

§ 371 Date: May 11, 2006

(30) Foreign Application Priority Data
Nov. 12, 2003 (IT) IM2003A000011

(51) Int. Cl. G04B 37/00

(52) U.S. Cl. 368/291

(57) ABSTRACT

A horology crystal (G) includes at least one portion having a minimum thickness of 3.5 mm in which there is formed a three-dimensional decoration that can be an internal laser engraving (S), a decorative item enclosed in the crystal (G) upon mould casting of the latter, or a plaquette of the same material of the crystal that is previously prepared with a print on the top surface and a print on the bottom surface and then subsequently integrated in the crystal (G) upon mould casting of the latter. Said horology crystal, preferably, has the shape of a spherical segment and is provided with a particular shaping along the bottom edge thereof and/or on the bottom, so that it can be removably mounted in the case (C) of a watch or wall/desktop clock. In this way it is possible to provide a much greater stand-out capacity to the decoration, with respect to the simple flat print on the dial, and said decoration can also be used to arrange the hour indicators on the watch, so that the dial can be simpler and cheaper in that it does not require the print or the small pieces usually applied thereon.

The present invention relates to horology crystals, and in particular to a crystal with a three-dimensional decoration. Reference will be made hereafter to conventional analogic watches, but it is clear that what is being said is also applicable to digital watches, as well as to desktop or wall clocks.

It is known that a watch in general essentially consists of a strap and a case containing the mechanisms, said case being closed at the top by a dial on which there are marked the hour indicators. The time is indicated by hands that rotate above the dial and are in turn protected by a transparent crystal.

In addition to the selection of the shapes of case and hands, the possibility of decoration of a watch for aesthetical of promotional purposes (e.g. with a logo) is limited to a print on one or more of the watch members such as the strap, the dial or the bottom of the crystal. It is clear that such a printed decoration is flat (two-dimensional) and therefore provides little stand-out capacity to the logo that is meant to be promoted.

Therefore the object of the present invention is to provide a horology crystal which overcomes said limitation. This object is achieved by means of a crystal including at least one portion having a minimum thickness of 3.5 mm in which there is formed a three-dimensional decoration.

The main advantage of this crystal is exactly that of providing great stand-out capacity to the decoration (logo, brand or simple aesthetic element), since said decoration can be three-dimensional.

A second advantage of the present crystal stems from the fact that it can be used to arrange the hour indicators on the watch, so that the dial can be simpler and cheaper in that it does not require the print or the small pieces usually applied thereon. In this case, if desired, you could even dispense with the dial and leave the watch mechanisms in sight.

Further advantages and characteristics of the horology crystal according to the present invention will be clear to those skilled in the art from the following detailed description of some embodiments thereof, with reference to the annexed drawings wherein:

FIG. 1 is a side view of a first embodiment of the crystal, with a convex top surface, with a first type of three-dimensional decoration formed by laser engraving;

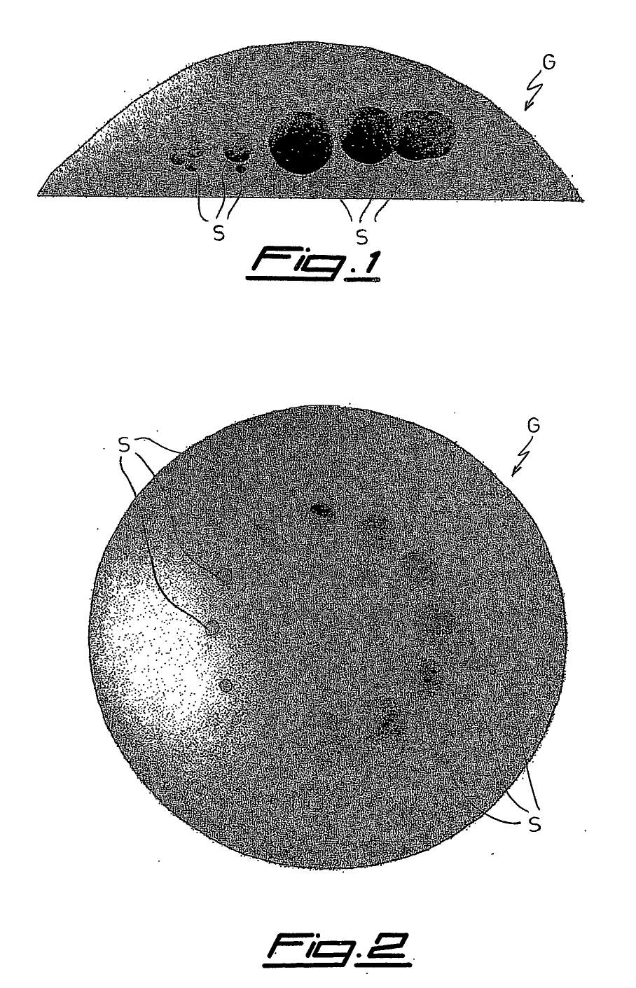

FIG. 2 is a top plan view of the crystal of FIG. 1;

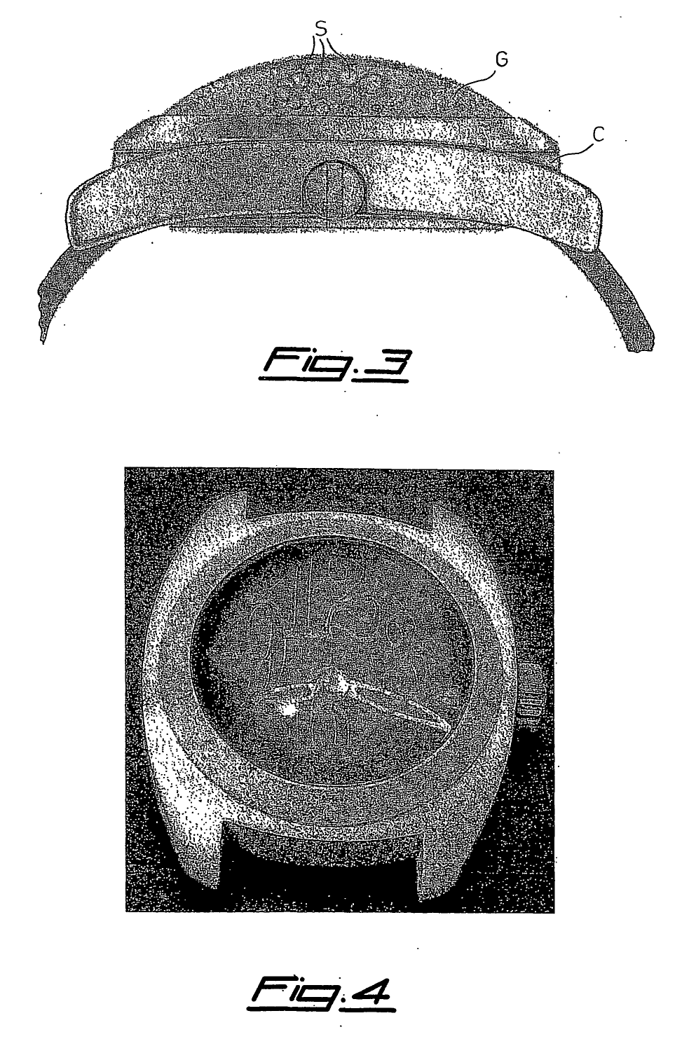

FIG. 3 is a side view of the crystal of FIG. 1 applied to a watch;

FIG. 4 is a front view showing a watch case with a laser engraved crystal suitable to arrange the hour indicators on the watch;

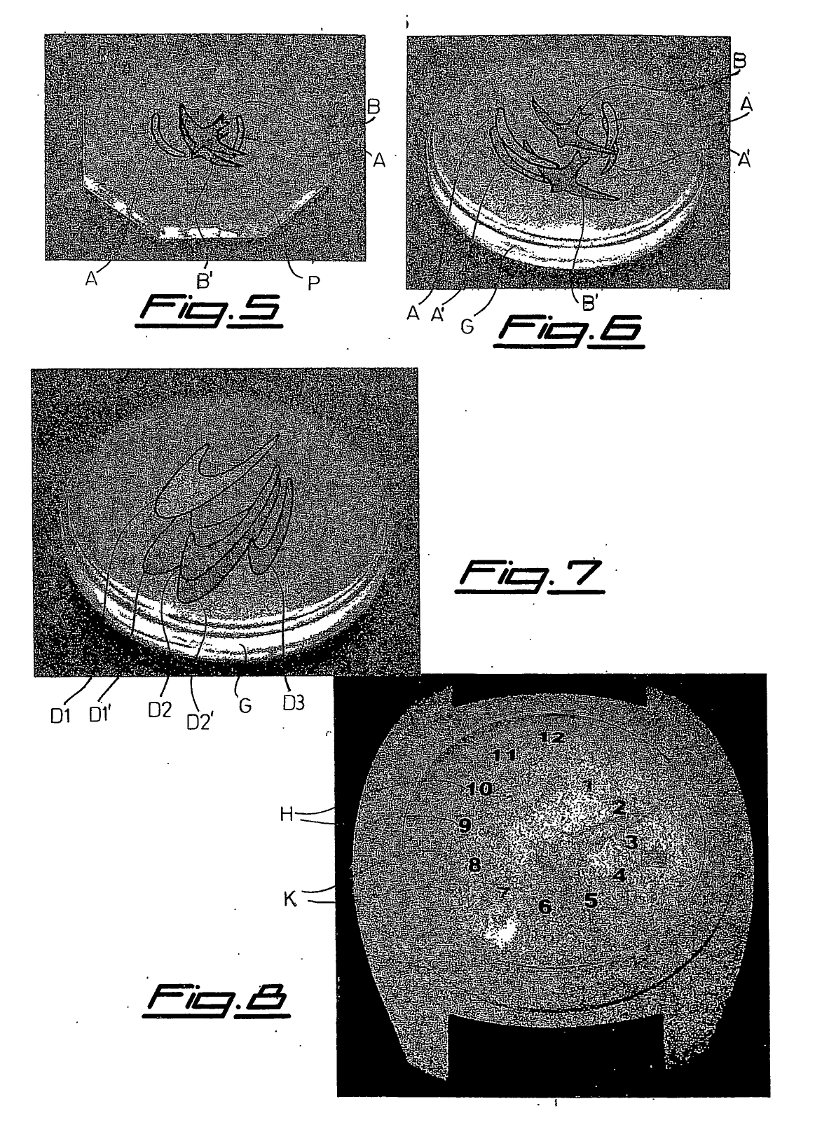

FIG. 5 is a front view of a printed transparent plaquette used to form a second type of three-dimensional decoration;

FIG. 6 is a front view of a convex crystal similar to the preceding ones, in which the decoration is formed by means of the plaquette of FIG. 5;

FIG. 7 is a front view of a convex crystal similar to the crystal of FIG. 6, in which there is also provided a print on the crystal bottom;

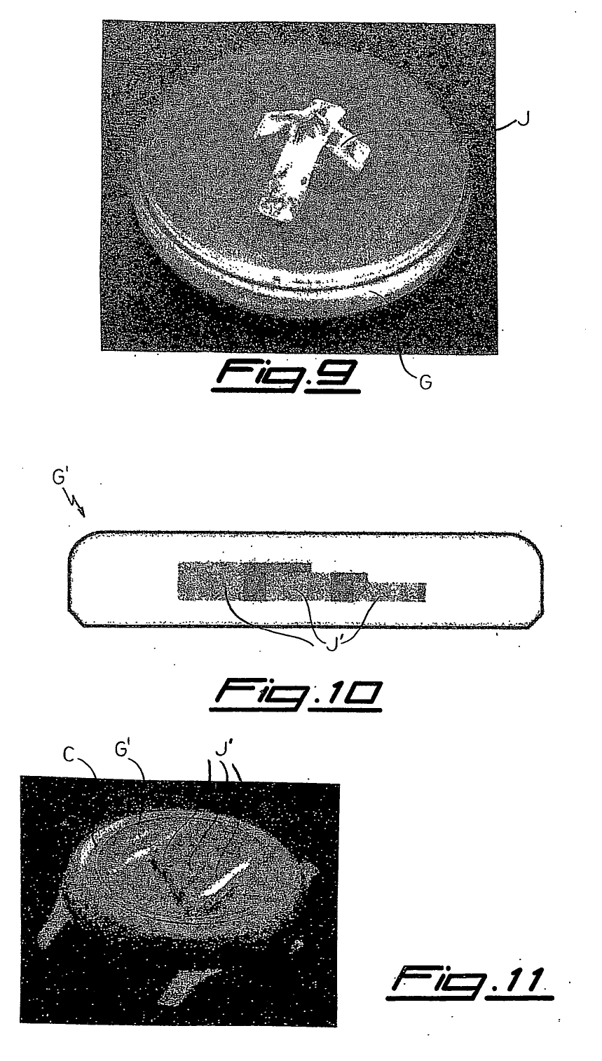

FIG. 8 is a front view showing a watch case with a plaquette-decorated crystal suitable to arrange the hour indicators on the watch;

FIG. 9 is a front view of a convex crystal similar to the preceding ones, in which a three-dimensional item is inserted to form a third type of decoration;

FIG. 10 is a diagrammatic side view of a second embodiment of the crystal, with a flat top surface, with the third type of three-dimensional decoration formed by insertion of an item;

FIG. 11 is a perspective view showing a watch case with the crystal of FIG. 10;

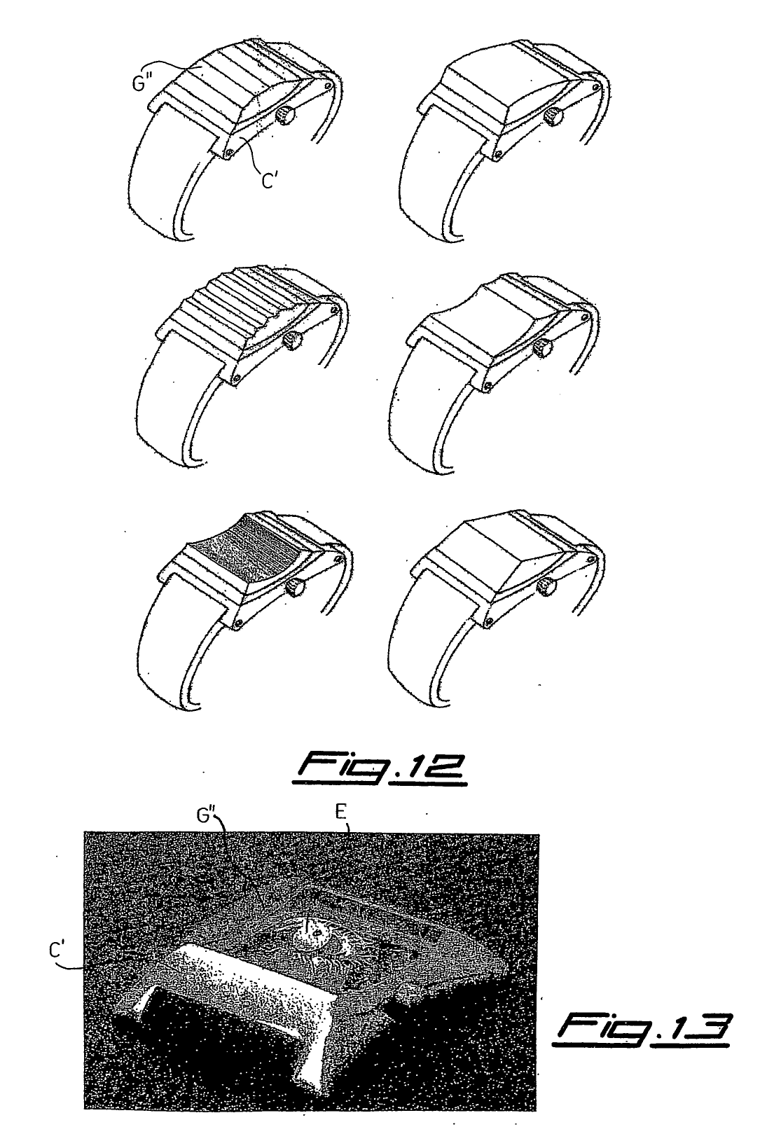

FIG. 12 shows diagrammatic perspective views of other six embodiments of the crystal, with different shapes; and

FIG. 13 is a perspective view showing a watch case with a further embodiment of the crystal, with plaquette decoration.

With reference to FIGS. 1-3, there is seen that a first embodiment of the crystal according to the present invention consists of a round crystal G with flat bottom and convex top surface with a substantially constant curvature, i.e. a spherical segment. Inside this crystal G, in the central portion of greater thickness, there is formed by a laser a three-dimensional decoration consisting of a circle of spheres S of increasing diameter.

It is clear that spheres S are just an example of the infinite possible three-dimensional decorations that can be formed through the known technique of internal laser engraving, already widely in use in the manufacturing of decorative objects and souvenirs. In brief, a low-power laser beam is focused with great precision at a point inside a block of glass or other transparent material (e.g. acrylic resin), so as to cause locally a micro-fracture. By forming numerous micro-fractures properly arranged inside the glass block, there is obtained a three-dimensional decoration precise to the small details though leaving the glass surface perfectly smooth and intact.

Once crystal G is mounted in the case C of a watch, the three-dimensional decoration will be visible not only from above but from the side as well (FIG. 3) and from any intermediate angle of sight, thus achieving the desired stand-out effect for the logo, brand or the like that would be used instead of spheres S.

As mentioned above, this type of laser engraving can be used also to arrange the hour indicators on the watch as illustrated in FIG. 4. In this way, the dial below the crystal can even be completely uniform, without any reference mark, small piece, print or the like since the hour indicators can be seen in transparency above the hands rather than below the hands as in conventional watches.

Referring now to FIGS. 5-7, there is illustrated a second type of three-dimensional decoration applicable to the above-described crystal G. In this case the decorative element consists of a plaquette, of the same material of the crystal, which is previously prepared with a print on the top surface and a print on the bottom surface, and is then subsequently integrated in the crystal upon mould casting of the latter. In this way it is possible to form coloured decorations that can not be obtained through laser engraving.

In the example illustrated in FIG. 5, there is seen an octagonal plaquette P with a bird contour B printed on the top surface and a pair of arches A printed on the bottom surface. The fact that bird B is printed on the top surface is proven by its reflection B′ on the bottom surface. It should be noted that the octagonal shape is selected only to facilitate the positioning in the mould, while it is clear that any shape will do since plaquette P is then integrated in the rest of the material of crystal G and its outline disappears.

The result of the insertion of the plaquette of FIG. 5 in the casting mould is illustrated in FIG. 6, where you can see how the two prints A and B seem to “float” inside crystal G. It should be noted that since plaquette P is located approximately at the center of crystal G, the reflection B′ of the bird contour B is now farther, and also arches A now have corresponding reflections A′ on the bottom surface of crystal G.

In order to add yet one more plane to the three-dimensional decoration in addition to the top and bottom surfaces of plaquette P, it is possible to provide also a further print on the bottom of the complete crystal G as shown in FIG. 7. In this case the decoration includes two stylized “check marks” D1, D2 printed on the top and bottom surfaces of the plaquette, respectively, with the corresponding reflections D1′ and D2′, with the addition of a further “check mark” D3 printed directly on the bottom of crystal G and therefore on the same plane of said reflections.

Also in this case, it is possible to use the plaquette decoration to arrange the hour indicators on the watch, as illustrated in FIG. 8. In particular, in the illustrated example there is provided a black print H on the top surface of the plaquette with hours from 1 to 12, and a grey print K on the bottom surface of the plaquette with hours from 13 to 24.

Finally, a third type of decoration is illustrated in FIG. 9, showing a crystal G with a decorative item inserted therein, specifically a cross J, that was placed in the casting mould in the same way as the above-mentioned plaquette P. Obviously, rather than cross J any other item of suitable size could be used, as well as elements acting as hour indicators.

FIGS. 10-11 show that the spherical segment shape of the above-illustrated crystal G is not the only possible shape, although it is preferable for the lens effect that produces a magnification of the decoration. These figures show a round crystal G′ with flat top surface, inside which there is inserted a plurality of small three-dimensional items J′ that make up an arrowhead-shaped decoration

Clearly, when such a crystal G is placed in a case C of a watch with the top surface flush therewith, decoration J′ is not visible from the side but it is still visible in its three-dimensional structure.

In practice, a crystal according to the present invention may have any shape as long as it has at least one portion of sufficient thickness to house a three-dimensional decoration of one of the above-described types. The shape of the crystal can in fact contribute to the creation of particular visual effects, in addition to having its own aesthetic value.

FIG. 12 shows other six possible shapes of a crystal G″ suitable for watches with a rectangular case C′, said crystals G″ being possibly provided with a top surface worked with faceting, grooves, knurls and the like in the central portion and two side faces. Finally, FIG. 13 shows yet another shape of crystal G″, having a top convex surface which is smooth in the central portion and provided with two side faces through which it is possible to see the internal eye-shaped decoration E.

It should be noted that given the particular aesthetic and/or promotional value of said crystal, it is preferable to make it so that it can be easily replaced. To this purpose, the crystal may be provided with a particular shaping along the bottom edge thereof and/or on the bottom, so that it can be removably mounted in the watch case, e.g. by embedding, with a threaded bezel that locks against a corresponding abutment or the like.

1. Horology crystal characterized in that it includes at least one portion having a minimum thickness of 3.5 mm in which there is formed a three-dimensional decoration.

2. Horology crystal according to claim 1, characterized in that said three-dimensional decoration is an internal laser engraving.

3. Horology crystal according to claim 1, characterized in that said three-dimensional decoration consists of at least one decorative item enclosed in the crystal upon mould casting of the latter.

4. Horology crystal according to claim 1, characterized in that said three-dimensional decoration consists of a plaquette, of the same material of the crystal, that is previously prepared with a print on the top surface and a print on the bottom surface, and then subsequently integrated in the crystal upon mould casting of the latter.

5. Horology crystal according to claim 1, characterized in that it includes a further print on the bottom of the crystal.

6. Horology crystal according to claim 1, characterized in that said decoration includes hour indicators.

7. Horology crystal according to claim 1, characterized in that it has the shape of a spherical segment.

8. Horology crystal according to claim 1, characterized in that it has a top surface with a central worked or convex portion and two side faces.

9. Horology crystal according to claim 1, characterized in that it is provided with a particular shaping along the bottom edge thereof on the bottom, so that it can be removably mounted in the case of a watch or clock.

10. Watch or wall/desktop clock characterized in that it includes a crystal according to claim 1.
